(19) United States
(12) Patent Application Publication
(10) Pub. No.: US 2025/0362085 A1
(43) Pub. Date: Nov. 27, 2025

(54) MELTING METHOD USING MULTIPLE IMPACTING FLAMES

(71) Applicant: L'Air Liquide, Societe Anonyme pour l'Etude et l’Exploitation des Procedes Georges Claude, Paris (FR)

(72) Inventors: Chaimae BARIKI, Paris (FR); Remi TSIAVA, Paris (FR)

(21) Appl. No.: 19/213,594

(22) Filed: May 20, 2025

(30) Foreign Application Priority Data
May 23, 2024 (FR) FRFR2405259

(51) Int. Cl. F27D 99/00; C03B 3/00; C03B 5/235; C03B 5/24; F27D 19/00

(52) U.S. Cl. CPC F27D 99/0001; C03B 3/00; C03B 5/2353; C03B 5/24; F27D 19/00; F27D 2019/0003; F27D 2099/004

(57) ABSTRACT

The melting method, wherein the unmelted charges form a pile 30 having a free surface 40 that is inclined relative to the vertical in the furnace 10; the unmelted charges are heated by means of flames 51, 52, 53 at a regulated power and momentum and are directed towards the free surface 40 in at least two directions α1, α2, α3 forming various acute angles θ1, θ2, θ3 with the horizontal plane so that the flames 51, 52, 53 define impact zones 41, 42, 43 on the free surface 40 that are located over at least two different vertical levels h1, h2, h3.

### CROSS-REFERENCE TO RELATED APPLICATIONS

This application claims the benefit of priority under 35 U.S.C. § 119 (a) and (b) to French patent application No. FR 2405259, filed May 23, 2024, the entire contents of which are incorporated herein by reference.

### BACKGROUND

The present invention relates to melting methods and furnaces.

### FIELD OF THE INVENTION

In melting methods, a known practice involves introducing the as yet unmelted charge (solid charge), hereafter called “unmelted charges”, into the furnace via chargers.

Pending melting, the unmelted charges then form a bank or one or more piles of unmelted charges (solids) in the furnace.

For example, in the case of some known glass melting furnaces, these unmelted charges float on the bath of already melted raw materials like a carpet and break up into several small islands as they advance through the furnace, before melting completely.

In melting methods, the known practice involves introducing the as yet unmelted charge into the furnace via chargers. The unmelted charges then form a bank or one or more piles of unmelted charges in the furnace

Depending on the charging mode that is used, the unmelted charges accumulate in the furnace in the form of one or more banks of varying heights that can even reach the roof of the furnace, and the width of which can equal the width of the furnace, or even can be in the form of one or more piles at such a height.

In all cases, the deposit of unmelted charges has a free surface that is generally inclined relative to the vertical.

Hereafter, the term “pile” is used to designate such deposits of unmelted charges assuming any shape, and therefore equally deposits of unmelted charges in the form of a bank and deposits of unmelted charges in the form of a pile.

### RELATED ART

It is known practice for the flames to be directed towards the pile of unmelted charges in order to melt the unmelted charges.

Heating the inclined free surface of a pile with a single flame in order to obtain controlled and/or fairly even melting on the free surface directed towards the flame is a challenge, particularly when the unmelted charges have low thermal conductivity.

Indeed, the distribution of the energy imparted to the unmelted charges depends on the geometry of the flame and its orientation towards the target surface. For example, in the case of a horizontal flame with a circular cross-section impacting the free surface of a bank of unmelted charges, the free surface is not perpendicular to the flame and the intersection of the flame with the target surface is inclined backwards, resulting in energy distribution to the detriment of the parts of the target surface farther away from the burner and the parts not impacted by the flame.

This results in heterogeneous heating and an imbalance in the melting of the pile: the zone receiving the most energy will melt first, leaving a hollow in the pile in its place. The zones of the pile receiving less energy will be delayed melting and can, for example, in a continuous furnace, move forward with the molten charge towards the furnace outlet.

Heterogeneous heating thus requires the furnace operator to slow down the charging of raw materials in order to ensure complete melting and, as the case may be, refining of the molten charge in the furnace, which results in a drop in production.

This problem is particularly pronounced in the case of unmelted charges with low heat conductivity.

### SUMMARY OF THE INVENTION

The aim of the present invention is to at least partly overcome the problem described above.

To this end, the invention proposes a melting method in which unmelted charges are introduced into a furnace by one or more chargers. In the furnace, these unmelted charges form a pile having a free surface that is inclined relative to the vertical. The surface area of the base of the pile is therefore greater than the surface area of the top of the pile.

According to the melting method, the unmelted charges in the pile are heated by means of flames directed towards said inclined free surface. Each of these flames impacts the free surface of the pile and defines an impact zone on this free surface.

According to the invention, these flames are directed towards the free surface in at least two directions forming various acute angles with the horizontal plane. In this way, the impact zones defined by the flames on the free surface are located over at least two different vertical levels.

The vertical level of an impact zone within the present context is understood to mean the height of the centroid or centre of mass of this zone.

Also according to the invention, the thermal energy transferred to the pile by each of these flames in its impact zone is regulated by regulating the power of the flame.

Furthermore, the momentum of each of these flames is regulated so that the flame impacts the free surface in its impact zone without the flame mechanically damaging the structural integrity of the pile in this impact zone.

The method according to the invention has several advantages.

The heating of the unmelted charges in the pile by the flames is distributed over the height of the pile.

The thermal energy transferred to each impact zone is regulated. Thus, it is possible to heat some impact zones more or less than other impact zones and to thus optimise the melting process. This type of regulation also avoids overheating the unmelted charges, which is important in the case of unmelted charges that can experience a drop in quality if overheated.

Finally, regulating the momentum of the flames ensures that each flame directed towards the free surface of the pile reaches, i.e., actually impacts, this free surface, but with a momentum that is such that the flame does not mechanically damage the structural integrity of the pile in its impact zone.

Within this context, a distinction is made between, on the one hand, the desired melting of the unmelted charges in the pile and its effect on the shape and the structure of the pile and, on the other hand, the mechanical degradation of the pile, notably by the flames and the combustion gases mechanically entrain unmelted charges of the pile. Such mechanical degradation can notably result in (i) the presence of unmelted charges in the molten charge discharged from the furnace or in an insufficiently refined molten charge, (ii) in the degradation of the interior of the furnace by the entrained unmelted charges and (iii) in the loss of unmelted charges discharged from the furnace with the combustion fumes.

As stated above, the flames are directed towards the free surface in at least two directions forming various acute angles with the horizontal plane. In this way, the impact zones defined by the flames on the free surface are located over at least two different vertical levels. Such a configuration therefore clearly differs from a combustion method in which many flames are generated in at least two directions forming various acute angles with the horizontal plane, but in which the flames merge into a single flame downstream of the burner. Indeed, such a merged flame would define a single impact zone on the free surface and not many impact zones at different vertical levels.

It should be noted that the present invention does not exclude the presence of heating means in the furnace other than the aforementioned flames directed towards the free surface. Such other heating means can notably include electrical heating elements and/or flames not directed towards the inclined free surface of the pile, for example, above or submerged in the molten charge in a refining zone.

The proposed method with, on the one hand, its regulation of the power of the impacting flames and, on the other hand, its regulation of the momentum of the impacting flames, thus resolves the imbalance in melting the pile observed in known melting methods and consequently increases the production of the furnace. Melting that is better distributed over the free surface of the bank directed towards the flames will result in the optimisation of the use of the thermal energy, which is an energy saving that will be even greater when the method is combined with a system for recovering thermal energy from the fumes discharged from the furnace. The energy that is recovered in this way advantageously can be used to heat one or more combustion reagents (oxidant and/or fuel) by means of a recuperator and/or to preheat at least a fraction of the unmelted charges before they are introduced into the furnace.

As indicated above, according to the method of the invention, flames are directed towards the free surface in at least two directions forming various acute angles with the horizontal plane so that said flames define impact zones on the free surface that are located over at least two different vertical levels. According to a preferred embodiment, the impact zones of these flames on the free surface are located over at least three different vertical levels, or even at least four different vertical levels. The number of vertical levels is selected as a function of the height of the pile and therefore also as a function of its free surface, as well as the size/shape of the impact zones. The size and shape of an impact zone depend on the geometry of the flame and of the impacted free surface, more specifically on the length, on the cross-section, which is defined by the burner generating the flame, on the opening angle of the impacting flame and on the shape and incline of the impacted free surface.

The impact zones can be positioned relative to each other in various ways.

For example, the impact zones located at a given vertical level can be positioned offset from the impact zones located over the vertical level below and/or located over the vertical level above.

However, in order to implement the method, it may be advantageous for the impact zones with at least two different vertical levels to have geometric centres that lie in the same vertical plane. Such a configuration notably can be achieved by means of flames directed towards the free surface, the directions of which (a) form various acute angles with the horizontal plane and (b) lie in said same vertical plane. In this case, it is possible to use the same burner to generate the many flames whose directions lie in this plane.

As indicated above, the impacting flames form acute angles with the horizontal plane and each impacting flame defines an impact zone on the free surface of the pile. Thus, when several such impacting flames have directions lying in the same vertical plane, said directions will normally diverge from one another towards the free surface of the pile in order to prevent said flames from coming together and mixing, thus merging into a single flame before impacting said free surface of the pile.

The impact zones of two adjacent impact zones can partially overlap.

According to a preferred embodiment and in order to ensure good distribution of the heating and melting of the impacted free surface, each of the impact zones partially overlaps the nearest impact zone.

In order to better manage the melting method, it can be worthwhile detecting the height of the pile in the furnace. To this end, the furnace can be provided with means for detecting the height or the profile of the pile in the furnace.

According to a useful embodiment, the number of different vertical levels of the impact zones is adjusted as a function of the height of the pile.

In this case, the flames corresponding to the impact zones with the highest vertical level are extinguished when the height of the pile falls below a given threshold (thus transitioning, for example, from impact zones with three vertical levels to impact zones with only two lower vertical levels), and the flames corresponding to impact zones with a higher vertical level are lit when the height of the pile exceeds a given threshold (thus transitioning, for example, from impact zones with two vertical levels to impact zones with three vertical levels, with the third added level being located above the two pre-existing levels). The two thresholds can be identical or different.

Indeed, the height of the pile in the furnace can vary, for example, as a function of the production of the furnace (also called the “draw” in the case of a continuous melting furnace), depending on the nature of the unmelted charges introduced into the furnace and/or the molten charge to be obtained. In the case of a discontinuous furnace (often called “batch furnace”), or a semi-continuous furnace (often called “semi-batch furnace”), the height of the pile can vary during melting: with the height of the pile in this case generally being at the maximum after the introduction of a “batch” of unmelted charges and decreasing as the melting of the unmelted charges progresses.

In the present context, a semi-continuous melting method or furnace is understood to mean a melting method or furnace in which some of the charge is added or subtracted during the melting cycle.

As indicated above, the furnace can be provided with means for detecting the height or the profile of the pile in the furnace. The height of the pile also can be visually checked by the furnace operator through a peep-hole in the furnace. The height of the pile and/or the evolution of this height during the melting method also can be estimated based on historical data.

When the pile assumes a shape or a position in the furnace in such a way that one or more of the flames that are generally directed towards the pile completely or partially pass above or next to the pile, these flames are advantageously extinguished, which thus do not impact the free surface of the pile, or which only partially impact the free surface of the pile.

By extinguishing the flames, which are generally directed towards the free surface but at least partially pass over or next to the pile of unmelted charges, the efficiency of the furnace is increased and there is no longer any risk of such a flame impacting and overheating, for example, the wall or a furnace charger located behind the pile towards the flame.

When the pile assumes a shape or a position in the furnace such that part of the free surface is not impacted by a flame, while the furnace has means (such as a burner) for directing an impacting flame towards this part of the free surface, one or more flames as defined above is/are advantageously added/ignited to impact this part of the free surface of the pile. For example, by adding one or more flames with an impact zone level closer to the top of the pile as the height of the pile increases, the distribution of the heating of the unmelted charges is better distributed over the free surface of the pile.

It also can be worthwhile detecting a position of the free surface of the pile in the furnace. Notably, it can be worthwhile detecting the positions of the free surface over at least one of the vertical levels of the impact zones defined by the flames directed towards this free surface.

The position of the free surface allows, for example, the state of forward or backward movement of the pile to be identified in a continuous melting furnace relative to the outlet for the molten charge of the furnace, with a pile that is too far advanced towards the furnace outlet increasing the risk of the presence of unmelted charges in the discharged molten charge and/or incomplete refining of the molten charge upstream of this outlet.

According to an advantageous embodiment, the method involves detecting whether the pile reaches a predefined forward movement distance in the direction of at least one of the flames directed towards the free surface. This predefined forward movement distance corresponds to the forward movement of the free surface and therefore of the melting front of the pile relative to its desired position. When the pile reaches this predefined forward movement distance, the overall power of the flames directed towards the free surface is increased. In this way, it is possible to cause faster melting of the unmelted charges in the pile and thus a backward movement of the free surface to its desired position.

According to another embodiment, which may or may not be combined with the previous embodiment, the method involves detecting the presence of the pile at a predefined backward movement distance in the direction of at least one of the flames directed towards the free surface. This predefined backward movement distance corresponds to the withdrawal of the free surface, and therefore of the melting front, from the pile relative to its desired position. When the pile does not reach this predefined backward movement distance, the overall power of the flames is reduced. In this way, it is possible to slow down the melting of the unmelted charges in the pile and eventually, notably with the introduction of additional unmelted charges into the furnace, to bring the free surface to its desired position.

As already indicated above, according to the present invention, the momentum of each flame directed towards the free surface is regulated so that the flame impacts the free surface without the flame mechanically damaging the structural integrity of the pile in the flame impact zone. Consequently, when the position of the free surface of the pile does not correspond or no longer corresponds to its desired position, an adjustment of the momentum of these flames also may be necessary in order to ensure that the flames impact the free surface at its actual position and/or in order to prevent the flame from mechanically damaging the structural integrity of the pile in the impact zone of the flame over the free surface in its actual position.

The pile assumes the form of a bank. Such a pile notably can be obtained when the unmelted charges are introduced into a continuous furnace through or on either side of the upstream wall of the furnace and the molten charge is discharged from the furnace through the downstream wall of the furnace, with the furnace being provided with one or more burners located on the side of the downstream wall and the one or more flames of which is/are directed towards a melting front of the bank forming a free surface that is inclined relative to the vertical towards the upstream wall.

The pile can also assume the form of a pile/stack, such as a substantially conical or frustoconical pile. Such a pile notably can be obtained when the unmelted charges are introduced into the furnace through the roof of the furnace.

The unmelted charges can also form several piles in the furnace, with each pile having a free surface. In this case, the method according to the invention is used to melt the unmelted charges in each pile.

The impacting flames result from the combustion of a fuel with an oxidant (i.e., a combustion oxidant).

The fuel can be a solid, liquid or gaseous fuel.

Advantageously, the fuel is a gaseous fuel. Such a gaseous fuel can be a carbon-based fuel, a non-carbon-based fuel or a mixture of carbon-based fuel and non-carbon-based fuel. Thus, the fuel particularly can be selected from the following gaseous fuels: natural gas, hydrogen, ammonia, synthesis gas, biogas, any gas containing hydrogen and/or carbon monoxide, and combinations of at least two of these gaseous fuels.

For environmental reasons, non-carbon fuels and renewable fuels with a low carbon footprint can be selected.

The oxidant/oxidiser typically has an oxygen content of 16% to 100% by volume. More oxygen rich oxidants/oxidisers, for example, with an oxygen content of at least 90% by volume, are typically more efficient and provide hotter flames, given their low content, or lack, of ballast gas that does not participate in combustion. However, for some applications, an oxidant/oxidiser with a higher ballast content, typically generating more diluted flames, can be preferable.

In order to generate the flames directed towards the free surface of the pile of unmelted charges, the furnace is equipped with at least one burner.

According to a useful embodiment, the furnace is equipped with at least one burner that generates many flames directed towards the free surface. According to a useful embodiment, the furnace is equipped with a plurality of burners each generating a single flame directed towards the free surface. A burner in the furnace thus can generate a single impacting flame or several impacting flames. The furnace also can be equipped with a combination of burners, including at least one such burner generating a single flame and at least one such burner generating several flames.

According to an advantageous embodiment, the furnace is equipped with at least one burner that generates flames, i.e., several flames, that are directed towards the free surface of the pile in at least two directions forming various acute angles with the horizontal plane so that the impact zones defined by these flames generated by this burner on the free surface are located over at least two different vertical levels.

According to a preferred embodiment, the furnace is equipped with at least one burner that generates at least two flames directed towards the free surface and the directions of which:
(a) form various acute angles with the horizontal plane;
(b) are located in said same vertical plane; and
(c) diverge from one another towards the pile/the free surface of the pile.

In order to implement the method, the melting furnace is generally equipped with:
one or more chargers for introducing the unmelted charges into the furnace;
one or more combustion devices, and notably one or more burners, for generating the flames directed towards the free surface;
a regulation unit for:
   regulating the power of the flames; and
   regulating the momentum of the flames.

In order to implement particular embodiments of the method according to the invention, the furnace also can be equipped with one or more of the following items of equipment:
a detector for detecting the height or the profile of the pile;
a detector for detecting a position of the free surface, preferably for detecting a position of the free surface over at least one of the vertical levels of the impact zones;
a detector for detecting whether or not the pile has reached a predefined forward movement distance;
a detector for detecting the presence or the absence of the pile at a predefined backward movement distance.

It should be noted that the same detector can be used for several detections. For example, it is possible to use a detector that detects the shape and the position of a pile in the form of a pile/stack, or a detector that detects the shape and the position of the melting front of a pile in the form of a bank.

When the furnace is equipped with one or more detectors, the furnace advantageously also comprises a control unit for controlling the regulation unit using data detected by the one or more detectors, for example, according to any one of the embodiments described above concerning the regulation of the power and the momentum of the impacting flames.

As mentioned above, the method can be a continuous method, i.e., with a continuous melting furnace, a discontinuous method, therefore, with a discontinuous melting furnace or a semi-continuous method, i.e., with a semi-continuous furnace.

In the case of a discontinuous or semi-continuous method, the melting method can also comprise a step during which the pile is substantially or completely melted and during which there is no inclined free surface on which flames define impact zones over at least two vertical levels. As the case may be, there may not be any combustion in the furnace during this step (particularly when this step is short and/or the heat losses from the furnace are low) or some (generally lower) level of combustion is maintained in order to refine the molten charge or to maintain it at the required temperature above the melting temperature of the charge.

According to particular embodiments, the method is a continuous or semi-continuous method, with the furnace having an upstream wall, through which or on the side of which the unmelted charges are introduced into the furnace, and a downstream wall opposite the upstream wall, through which or on the side of which the molten charge is discharged from the furnace.

According to a particular embodiment, the impacting flames are directed towards the free surface of the pile through the downstream wall or on the side of the downstream wall, for example, through the roof and/or through the or one of the side walls connecting the upstream wall to the downstream wall.

In the present context, “from the side of a wall” is understood to mean: within half the length of the furnace adjacent to said wall, preferably within a third, or even a quarter or a fifth, of the length of the furnace adjacent to said wall.

The method according to the invention is preferably a method for melting glass, a method for melting enamel, a method for melting non-ferrous metal, such as aluminium, lead, copper, etc., and in particular such a method for the second melting of non-ferrous metal, more specifically within the context of recycling one or more non-ferrous metals, for melting hydraulic binder or for vitrifying waste. Consequently, the furnace is preferably a furnace selected from among glass melting furnaces, enamel melting furnaces, non-ferrous metal melting furnaces, hydraulic binder melting furnaces and waste vitrification furnaces.

### BRIEF DESCRIPTION OF THE FIGURES

FIG. 1 is a schematic representation, as a cross-section, of a furnace in which the method according to the invention is implemented.

### DETAILED DESCRIPTION OF THE INVENTION

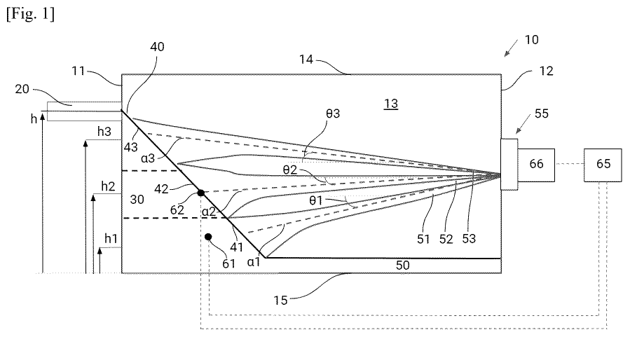

The present invention and its advantages will be better understood in the light of the following non-limiting example, with reference to FIG. 1, which is a schematic representation, as a cross-section, of a furnace in which the method according to the invention is implemented.

FIG. 1 more specifically shows a continuous furnace 10 for melting glass.

Furnaces of the illustrated type assume a parallelepiped shape and generally have a length of less than 10 metres, a width of less than 5 metres and a height of less than 3 metres.

The furnace 10 has an upstream wall 11, through which the unmelted charges (i.e., the solid vitrifiable composition) is introduced into the furnace 10, and a downstream wall 12, opposite the upstream wall 11, and through which the molten glass 50 is discharged from the furnace 10.

Two side walls connect the upstream wall 11 and the downstream wall 12, with the rear side wall 13 being visible in FIG. 1.

The furnace 10 also has a roof 14 and a bottom 15, with the melting zone being located between the upstream wall 11, the downstream wall 12, the side walls 13 and the other side wall, the roof 14 and the bottom 15.

The solid vitrifiable composition is made up of or comprises small particles with low thermal conductivity compared with the thermal conductivity of metals. These particles therefore transmit little or no thermal energy between them.

The unmelted charges are introduced into the furnace 10 through the upstream wall 11, for example, by means of an endless screw 20. Inside the furnace 10 they form a pile 30 in the form of a bank with a height h (measured from the bottom 15) that extends above the molten glass 50. On the upstream side of the furnace 10, the bank 30 of unmelted charges rests against the upstream wall 11. Towards the downstream side, the bank 30 ends at a free surface 40 that is inclined relative to the vertical.

In order to heat and melt the unmelted charges, the free surface 40 is attacked over various vertical levels by the fan-shaped flames 51, 52, 53 generated by one or more burners 55 mounted in the downstream wall 12. The free surface 40 consequently forms a melting front for the unmelted charges in the furnace 10.

The furnace 10 illustrated in FIG. 1 is a small furnace, with the bank 30 to be melted on the upstream wall 11 side and the one or more burners 55 on the opposite downstream wall 12. The one or more burners 55 is/are selected so as to emit a flame length that matches the length of the furnace 10. The molten material 50 moves over the bottom 15 of the furnace 10 towards the burner 55, below which an outlet hole (not illustrated) is located for the molten material 50. The molten material 50 thus moves under the flames 51, 52, 53, which keep it molten until it leaves the furnace 10.

For larger furnaces, the bank 30 to be melted remains on the side of the upstream wall 11, but additional burners are added. These additional burners can be installed, for example, on the side walls 13 connecting the upstream wall 11 and the downstream wall 12, in the roof 14 or in the bottom 15, for “submerged burners”.

Each flame 51, 52, 53 defines an impact zone 41, 42, 43 on the free surface 40, where it causes the unmelted charges to melt.

The flames 51, 52, 53 are directed towards the free surface 40 in different directions α1, α2, α3 (depicted by the axes of the flames 51, 52, 53) forming various acute angles θ1, θ2, θ3 with the horizontal plane. In this way, the respective impact zones 41, 42, 43 of the flames 51, 52, 53 are located over vertical levels h1, h2, h3 (as defined above) different from the free surface 40.

The thermal energy transferred to the unmelted charges in the bank 30 by each flame 51, 52, 53 via its respective impact zone 41, 42, 43 is regulated by regulating the power of the corresponding flame 51, 52, 53. By regulating the power of the flames 51, 52, 53, the melting rate of the unmelted charges in the vicinity of the corresponding impact zone 41, 42, 43 is also regulated. This notably prevents the bank 30 from being destabilised and therefore mechanically damaged by the unmelted charges melting too quickly at the base of the bank 30, or even by the unmelted charges melting too slowly in the middle or at the top of the bank 30.

By regulating the overall power of the flames 51, 52, 53 and therefore also the thermal energy transferred to the unmelted charges in the bank 30 by all the flames 51, 52, 53 via the various impact zones 41, 42, 43, it is possible to adjust the overall melting rate of the unmelted charges and consequently also the height h of the bank 30 and/or the forward movement position of the free surface 40 of the bank 30 in the furnace.

The momentum of each flame 51, 52, 53 is also regulated. This momentum is more specifically regulated so that the flames 51, 52, 53, on the one hand, impact the free surface 40 of the bank 30, which allows more effective heating of the unmelted charges, and, on the other hand, do not mechanically damage the structural integrity of the bank 30.

Since the momentum of the flames 51, 52, 53 is regulated so that said flames 51, 52, 53 impact the free surface 40, the flames that correspond to impact zones farthest from the root of the flame/burner 55, 56, 57 typically have stronger momentums than the flames that correspond to impact zones closer to the root of the flame/burner 55.

As indicated above, in the present context, a distinction is made between, on the one hand, changing the pile by melting the unmelted charges and, on the other hand, the mechanical degradation of the structural integrity of the pile by high momentum flames, notably by the unmelted charges of the pile being uncontrollably mechanically entrained by such flames and/or by the combustion fumes/gas generated by such flames.

In order to regulate the momentum of the flames 51, 52, 53, the distance between the free surface 40 and the root of the flames 51, 52, 53/the outlet of the one or more burners 55 generating the flames 51, 52, 53 and the nature of the unmelted charges is therefore taken into account.

Thus, when the bank is made up of large and heavy pieces of non-ferrous metal that are difficult to entrain, the momentum of the flames can be relatively high.

By contrast, when the bank is made up of or comprises unmelted charges in the form of light particles/fine particles/powders, as in the illustrated embodiment, and in particular such fine particles/powders that do not stick together when they enter the furnace, the momentum of the impacting flames must remain fairly low in order to avoid such entrainment or in order to avoid significant entrainment of said particles.

It should be noted that such destabilisation/such entrainment can result in:
(i) the presence of unmelted charges in the molten charge discharged from the furnace or an insufficiently refined molten charge, which can cause problems in the methods downstream of the melting step, such as the shaping of solid products from the molten charge, and a reduction in the quality of the manufactured solid products;
(ii) degradation of the interior of the furnace, for example: erosion of the walls by entrained unmelted charges and the formation of deposits on burners or other equipment in contact with the interior of the furnace; and/or
(iii) the loss of unmelted charges discharged from the furnace with the combustion fumes. Such a loss of raw materials is obviously costly. It can also cause blockages in the flue gas evacuation ducts and accelerated saturation of the filters used for flue gas treatment upstream of the chimney. When the furnace comprises a system for recovering thermal energy from the exhaust fumes, the presence of unmelted charges in the fumes also poses problems for heat recovery in the recuperators or regenerators that are used. Furthermore, when the charge is a mixture of various ingredients, as is notably generally the case for glass melting methods, the discharge of unmelted charges with the combustion fumes can be selective, with various discharge levels for various ingredients. In this case, the composition of the molten charge that is obtained does not correspond to that resulting from the composition of the unmelted charges introduced into the furnace, with obvious consequences for the methods for treating the molten charge downstream of the furnace and for the properties of the final product that is obtained.

Burners allowing such dual regulation, on the one hand, of the power of the one or more generated flames and, on the other hand, of the momentum of the one or more generated flames are known. Such burners are described, for example, in WO-A-2010/003866. Such a burner allows, for example, modification of the power of the constant-momentum flame or modification of the momentum of the constant-power flame.

The flames 51, 52, 53, and in particular the flame 53 corresponding to the impact zone 43 of the highest vertical level h3, can be extinguished individually, notably as a function of the melting state of the bank 30 and/or in particular as a function of the height h of the bank 30. Such an embodiment is particularly flexible and efficient and can be adapted to changes in the composition or structure (particle size) of the charge and/or in the desired productivity level of the furnace. Such an embodiment is also particularly useful for discontinuous and semi-continuous processes, which have the de facto feature whereby the height of the one or more piles 30 varies when melting the unmelted charges.

In some cases, the position, the height h, or even the shape of the pile 30 in the furnace, and any changes thereto during the melting method, are known to the furnace operator.

However, it is generally desirable for one or more of these features to be detected since they are features that allow the melting method to be optimised.

According to one advantageous embodiment, electromagnetic beams, and notably laser beams, are used to detect the position of the pile 30, the height of the pile 30, the free surface 40 or one or more of the impact zones 41, 42, 43 during the melting method.

According to the illustrated embodiment, two electromagnetic beams 61, 62 are directed from one side wall towards detectors in the opposite side wall 13.

When the bank 30 of unmelted charges is opposite one of these beams 61, 62, the bank 30 intersects this laser beam 61, 62 and no signal is detected by the corresponding detector. When the bank 30 does not intersect the laser beam 61, 62, the corresponding detector detects the beam 61, 62, which means that there is no pile of unmelted charges at this point in the furnace 10.

A first electromagnetic beam 62 is directed from one side wall 13 to the other at a position corresponding to a predetermined maximum forward movement position of the free surface 40 and therefore of the melting front of the pile 30. When there is a melting delay in such a melting furnace 10, the pile 30 of unmelted charges advances towards the outlet for the molten charge in the downstream wall 12. As the pile 30 advances towards the furnace outlet, the impact zones 41, 42, 43 on the free surface 40 of the pile 30 approach the root of the corresponding impacting flame 51, 52, 53/burner 55 generating this impacting flame 51, 52, 53. When the pile 30 intersects the electromagnetic beam 62 (as illustrated in the FIGURE where the pile intersects the beam 62 at the impact zone 42), a signal is transmitted to a control unit 65 of the furnace 10 in order to indicate the state of forward movement of the pile 30. In response, the control unit 65 transmits a control signal to the regulation unit 66 of the one or more burners 55 so that the overall power of the impacting flames 51, 52, 53 is increased, while distributing the power of the individual flames 51, 52, 53 so as not to destabilise the structural integrity of the pile 30 on its free surface 40 and risk the uncontrolled collapse thereof.

Also according to the illustrated embodiment, an electromagnetic beam 61, such as a laser beam, is directed from one side wall 13 to the other, at a position that corresponds to a predetermined minimum forward movement position of the pile 30 of unmelted charges towards the outlet of the furnace 10 for the molten charge 50. When the free surface 40 of the pile 30 is upstream of this minimum forward movement position, the electromagnetic beam 61, 62 is not or is no longer intersected by the pile 30 and the beam 61 impacts the corresponding detector in the side wall 13. In this case, a corresponding signal is transmitted to the control unit 65 of the furnace 10, which control unit in turn transmits a control signal to the control unit 66 of the one or more burners 55 so that the overall power of the impacting flames 51, 52, 53 is reduced, while distributing the power of the individual impacting flames 51, 52, 53 so as to avoid destabilising the bank 30 and the risk of it collapsing. This reduction in the overall power can include the temporary extinction of one or more impacting flames 51, 52, 53 by the regulation unit 66.

Based on the detection signals that are obtained, the control unit 65 can then compare the one or more detected distances detected with a predetermined maximum forward movement position and/or with a predetermined minimum forward movement position and send the control unit 66 of the one or more burners 55 a control signal for regulating the overall power of the flames 51, 52, 53 as described in more detail above.

Said detection signals also can be used to cause an individual adjustment, via an increase or a decrease, in the momentum and/or the power of the impacting flame 51, 52, 53 whose distance between the root of the flame 51, 52, 53/the outlet of the corresponding burner 55 and its impact zone 41, 42 43 has been detected. For example, depending on the detection signal that is obtained, the control unit 65 can send the regulation unit 66 of the relevant burner a control signal for adjusting the momentum of the flame 51, 52, 53 in question so that this flame 51, 52, 53 effectively impacts its impact zone 41, 42, 43 on the free surface 40, without it damaging the structural integrity of the pile 30.

It is also possible to detect the height of the pile 30.

According to one embodiment, an electromagnetic beam is directed from one wall to an opposite wall at a position near the top of the pile 30. In the event that this detection reveals that the upper part of the pile 30 targeted by the detection has melted and therefore no longer intersects the electromagnetic beam, a detection signal is transmitted to the control unit 65, with the control unit 65 then transmitting a control signal to the regulation unit 66 of the one or more burners 55 so that the one or more flames 51, 52, 53 with a direction α1, α2, α3 aiming at an impact zone 41, 42, 43 on this upper part of the pile 30, and that therefore no longer or only partially impact the pile 30 when this upper part is melted, are extinguished, in order to maintain high energy efficiency for the furnace 10 and to avoid damaging the walls or other elements of the furnace 10 (such as, for example, the charger, as a result of being impacted by this flame or these flames).

According to an advanced embodiment, the position and the profile/shape of the pile 30 inside the furnace 10 are detected, for example, by optical imaging means, and the power of the impacting flames is regulated accordingly, as described above.

It is possible to detect and correct local melting that is too advanced or not advanced enough in one or more impact zones 41, 42, 43 on the free surface 40, or even to correct localised collapsing of the free surface 40, by individually adjusting the power of one or more impacting flames 51, 52, 53 specifically directed towards these impact zones 41, 42, 43 on the free surface of the pile 30, without necessarily changing the heat transfer by impacting flames 51, 52, 53 towards other zones 41, 42, 43 on the free surface 40 of the pile 30.

While the invention has been described in conjunction with specific embodiments thereof, it is evident that many alternatives, modifications, and variations will be apparent to those skilled in the art in light of the foregoing description. Accordingly, it is intended to embrace all such alternatives, modifications, and variations as fall within the spirit and broad scope of the appended claims. The present invention may suitably comprise, consist or consist essentially of the elements disclosed and may be practiced in the absence of an element not disclosed. Furthermore, if there is language referring to order, such as first and second, it should be understood in an exemplary sense and not in a limiting sense. For example, it can be recognized by those skilled in the art that certain steps can be combined into a single step.

The singular forms “a”, “an” and “the” include plural referents, unless the context clearly dictates otherwise.

“Comprising” in a claim is an open transitional term which means the subsequently identified claim elements are a nonexclusive listing i.e. anything else may be additionally included and remain within the scope of “comprising.” “Comprising” is defined herein as necessarily encompassing the more limited transitional terms “consisting essentially of” and “consisting of”; “comprising” may therefore be replaced by “consisting essentially of” or “consisting of” and remain within the expressly defined scope of “comprising”.

“Providing” in a claim is defined to mean furnishing, supplying, making available, or preparing something. The step may be performed by any actor in the absence of express language in the claim to the contrary.

Optional or optionally means that the subsequently described event or circumstances may or may not occur. The description includes instances where the event or circumstance occurs and instances where it does not occur.

Ranges may be expressed herein as from about one particular value, and/or to about another particular value. When such a range is expressed, it is to be understood that another embodiment is from the one particular value and/or to the other particular value, along with all combinations within said range.

All references identified herein are each hereby incorporated by reference into this application in their entireties, as well as for the specific information for which each is cited.

1: A melting method, comprising:
introducing unmelted charges into a furnace via one or more chargers;
forming in the furnace, pile from the unmelted charges having a free surface that is inclined relative to the vertical;
heating the unmelted charges in the pile by means of flames directed towards the free surface, with each flame defining an impact zone on the free surface of the pile;
wherein,
the flames are directed towards the free surface in at least two directions forming various acute angles with the horizontal plane so that the impact zones defined by the flames on the free surface are located over at least two different vertical levels; and
the thermal energy transferred to the pile by each flame in the respective impact zone is regulated by regulating the power of the flame;
the momentum of each flame is regulated so that the flame impacts the free surface in the impact zone without the flame mechanically damaging the structural integrity of the pile in this impact zone.

2. The method according to claim 1, wherein the impact zones of the flames on the free surface are located over at least three different vertical levels.

3. The method according to claim 1, wherein the impact zones with at least two different vertical levels have geometric centres that lie in the same vertical plane.

4. The method according to claim 1, wherein each impact zone partially overlaps the nearest impact zone.

5. The method according to claim 1, wherein the height of the pile is detected.

6. The method according to claim 1, wherein the one or more flames with an impact zone that at least partially exceeds the height h of the pile is/are extinguished.

7. The method according to claim 1, wherein the number of different vertical levels of the impact zones is adjusted as a function of the height of the pile.

8. The method according to claim 1, wherein a position of the free surface is detected over at least one of the vertical levels of the impact zones.

9. The method according to claim 1, involving detecting whether the pile reaches a predefined forward movement distance in the direction of at least one of the flames directed towards the free surface and involving increasing the overall power of the flames when the pile reaches this predefined forward movement distance.

10. The method according to claim 1, involving detecting the presence of the pile at a predefined backward movement distance in the direction of at least one of the flames directed towards the free surface and involving reducing the overall power of the flames when the pile does not reach this predefined backward movement distance.

11. The method according to claim 1, wherein the pile is in the form of a bank or a pile/stack.

12. The method according to claim 1, wherein the furnace is equipped with at least one burner that generates flames that are directed towards the free surface in at least two directions forming various acute angles with the horizontal plane so that the impact zones defined by these flames generated by this burner on the free surface are located over at least two different vertical levels.

13. The method according claim 1, wherein the method is a continuous, discontinuous or semi-continuous method.

14. The method according to claim 1 for melting glass, enamel, non-ferrous metal, hydraulic binder or for vitrifying waste.
